(19) United States
(12) Patent Application Publication
(10) Pub. No.: US 2010/0070949 A1
(43) Pub. Date: Mar. 18, 2010

(54) PROCESS AND SYSTEM FOR ASSESSING MODULARITY OF AN OBJECT-ORIENTED PROGRAM

(75) Inventors: Girish Maskeri RAMA, Bangalore (IN); Santonu SARKAR, Bangalore (IN); Avinash KAK, West Lafayette, IN (US)

Correspondence Address: CANTOR COLBURN, LLP, 20 Church Street, 22nd Floor, Hartford, CT, 06103, US

(73) Assignee: INFOSYS TECHNOLOGIES LIMITED, Bangalore (IN)

(21) Appl. No.: 12/558,860

(22) Filed: Sep. 14, 2009

(30) Foreign Application Priority Data
Sep. 15, 2008 (IN) 2231/CHE/2008

(51) Int. Cl. G06F 9/44

(52) U.S. Cl. 717/125; 717/127

(57) ABSTRACT

The present invention describes a process, system and computer program product for assessing the modularity of an object-oriented program. The process includes calculation of metrics associated with various properties of the object-oriented program. Analysis is performed on the basis of the calculated metrics.

### BACKGROUND

The present invention relates to object-oriented programming. More specifically, it relates to assessing the modularity of an object-oriented program.

A software application built using object-oriented programming techniques has modular architecture. Thus, the software application includes one or more modules that implement various functionalities by defining classes, objects, methods, etc. According to the best programming practices, each module should be cohesive and the degree of coupling among the modules should be minimum. Coupling of a module is determined by the degree of dependency the module has on other modules of the software application. Cohesion associated with the module is determined by the degree of similarity between the functions the module performs. Coupling and cohesion determine the degree of modularization of the software application. A low degree of coupling and a high degree of cohesiveness enable the programmer to easily maintain and extend the software application. Extending the software application is required to update/change the software application according to the changing requirements of users. For example, a banking enterprise may wish to offer additional features to the users of net banking. In this case, the programmers of the net banking software need to extend/change the software to incorporate the additional features.

As the size of the object oriented program of the software application grows, the modules become interdependent. Various properties of object-oriented programming result in this interdependence, such as a module extending the class of another module, a class in a module using an instance of a class defined in another module as an attribute or a parameter in method definition, and a method in a class of a module calling a method defined in another module. Due to the interdependence, making a change in a module affects the functionalities of the other dependent modules. Therefore, corresponding changes need to be made in all the dependent modules. As a result, such a software application is difficult to extend and maintain. Consequently, it is important to monitor the degree of modularization for the software application.

Currently, methods are available to determine the degree of modularization for non-object-oriented systems such as procedural systems. These metrics do not take into account the interdependence induced among the modules due to the properties of object-oriented programming, such as inheritance, polymorphism, encapsulation, state access, and containment. Further, there are methods available for measuring the degree of modularization associated with a property of the object-oriented program. However, the degree of modularization is calculated only at the level of classes. Therefore, for large object-oriented programs consisting of hundreds of classes, calculating modularity at the level of classes for each property is not feasible.

In light of the above discussion, there is a need for a method and system for quantitatively measuring the degree of modularization for a software application built on the object-oriented architecture.

### SUMMARY

An object of the invention is to assess the modularity of an object-oriented program.

Another object of the invention is to graphically represent the results of the assessment of the modularity.

The invention provides a process, system and computer program product for assessing the modularity of an object-oriented program. A plurality of properties is associated with the object-oriented program. The object-oriented program includes a plurality of modules. At least one module of the plurality of modules includes one or more classes and one or more Application Programming Interfaces (APIs). Further, at least one class of the one or more classes includes one or more attributes and one or more methods. At least one metric is calculated for each of the at least one module of the plurality of modules. Each metric of the at least one metric is associated with one property of the plurality of properties associated with the object-oriented program. The property associated with the each metric is at least one of API-based coupling of the at least one module, inheritance-based coupling of the at least one module, association-based coupling of the at least one module, state access-based coupling of the at least one module, size of the at least one module, and use of the at least one module.

The at least one calculated metric is analyzed, based on a predefined threshold value. Based on the analysis of the at least one calculated metric, graphical reports are generated.

The process, system and computer program product described above have a number of advantages. The process enables calculation of metrics to quantitatively measure the modularity of the object-oriented program. Further, these metrics are calculated at the level of modules and based on various properties of the object-oriented program, such as interdependence induced among the modules due to properties such as inheritance, polymorphism, abstraction and containment. Since the metrics are calculated at the level of modules, the present invention overcomes the disadvantages of calculating the metrics at the level of classes. Furthermore, the system displays the calculated values of the metrics in the form of graphical reports to the users. These graphical reports enable the users to monitor the modularity of the object-oriented program and identify the reasons for degradation in modularity.

### BRIEF DESCRIPTION OF THE DRAWINGS

The various embodiments of the invention will hereinafter be described in conjunction with the appended drawings, provided to illustrate and not to limit the invention, wherein like designations denote like elements, and in which:

FIG. 1 is a flow diagram illustrating the process for assessing the modularity of an object-oriented program, in accordance with an embodiment of the invention;

FIG. 2 is an exemplary graphical report illustrating the results of the assessment of the modularity of the object-oriented program, in accordance with an embodiment of the invention; and

FIG. 3 is a block diagram of a system configured for assessing the modularity of the object-oriented program, in accordance with an embodiment of the invention.

### DESCRIPTION OF VARIOUS EMBODIMENTS

The invention describes a process, system and computer program product for assessing the modularity of an object-oriented program. The process includes calculating metrics based on a plurality of properties associated with the object-oriented program. The calculated metrics are presented to the users in the form of graphical reports. The process for assessing the modularity of the object-oriented program has been described below in detail.

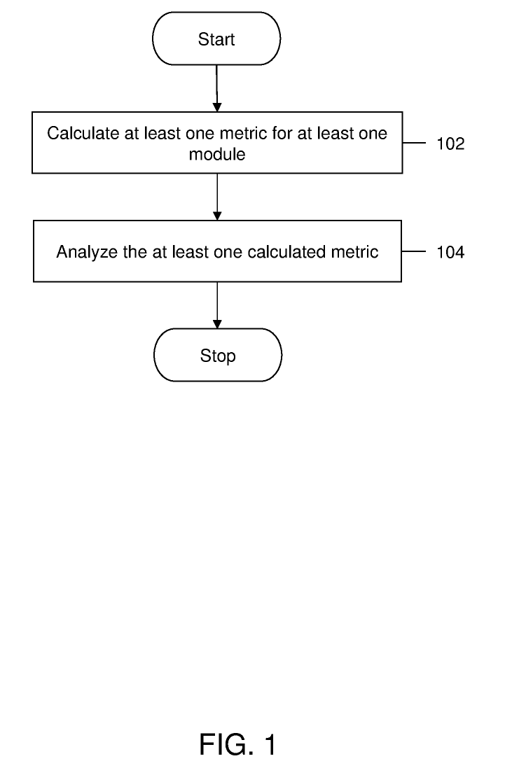

FIG. 1 is a flow diagram illustrating a process for assessing the modularity of an object-oriented program. The object-oriented program is associated with a plurality of properties. The plurality of properties includes, but is not limited to, inheritance, polymorphism, abstraction, containment, state access, use, size, association, plugin extension and encapsulation. Further, the object-oriented program includes a plurality of modules. Furthermore, at least one module of the plurality of modules includes one or more classes and one or more Application Programming Interfaces (APIs). In addition, at least one class of the one or more classes includes one or more methods and one or more attributes.

At step 102, at least one metric is calculated for each of the at least one module. Each of the at least one metric is calculated based on a property of the plurality of properties. In an embodiment of the invention, the property considered for the calculation of the metric is one of API-based coupling of the module, inheritance-based coupling of the module, association-based coupling of the module, state access-based coupling of the module, size of the module, and use of the one module. The metric associated with each property is a quantitative measure of the modularity of the module. It may be apparent to any person skilled in the art that calculating the metric for each of the modules of the object-oriented program facilitates assessment of the modularity of the object-oriented program.

The modularity of the object-oriented program is determined by coupling among the plurality of modules and cohesion associated with each module of the plurality of modules. Coupling of the module is determined by the degree of dependency the module has on the other modules of the plurality of modules. Cohesion associated with the module is determined by the degree of similarity between the various functions performed by the module. An ideal object-oriented program has a low degree of coupling and a high degree of cohesion.

According to the various embodiments of the invention, the metric calculated, based on each property of the object-oriented program, is as given below:

1. Metrics Associated with API-Based Coupling of the Module

An API of the module determines the way the module interacts with the other modules of the object-oriented program. The module includes one or more APIs that can be broadly categorized as Service-APIs (S-APIs) and Extension-APIs (E-APIs).

The S-APIs declare methods that should be called by the other modules of the object-oriented program. The E-APIs of the module declare abstract classes and abstract methods of the module. The E-APIs facilitate adding a new functionality to the module by using a plug-in. The plug-in adds the new functionality to the module by accessing these abstract classes and methods without requiring access to the source code of the module.

In an embodiment of the present invention, there are four metrics associated with the API-based coupling of the module. They are Module Interaction Index (MII), Non-API Closedness Index (NC), Not Programming Interface Index (NPII) and API Cohesiveness and Segregation (APIU).

The calculation of these metrics has been further explained below in detail.

a. Module Interaction Index (MII)

In an embodiment of the invention, the metric associated with the API-based coupling of the module represents the degree of interaction between the module and the other modules through the methods declared in the APIs. The metric is calculated, based on a first set of external calls and a second set of external calls. The first set of external calls includes external calls made to a subset of the one or more methods of the module. The subset of methods includes all the methods declared in the APIs of the module. The external calls originate from classes or methods that reside outside the module. Similarly, the second set of external calls includes external calls made to any of the one or methods of the module. Further, the second set of external calls includes external calls made to the methods of the other classes of the one or more classes. In an ideal object-oriented program, the number of external calls in the first set of external calls is equal to the number of external calls in the second set of external calls.

In an embodiment of the present invention, the first set of external calls made to the methods declared in an API, denoted as (API 0 of the one or more APIs of the module p, is denoted as ExtCallRel(i). All the APIs of the module p are denoted as I(p).

ExtCallRel(i)={<m_{f},mₜ>|Call(m_{f},mₜ) [symbol] mₜ∈M(i) [symbol] m_{f}∉M(p)}

### Where,

Call(m_{f}, mₜ) denotes a predicate, which is true when method m_{f} calls method mₜ,
M(i) denotes a set of methods declared in API i, and
M(p) denotes a set of methods declared in module p.

The second set of external calls made to the methods defined in module p is denoted as ExtCallRel(p).

ExtCallRel(p)={<m_{f},mₜ>|Call(m_{f},mₜ) [symbol] mₜ∈M(p) [symbol] m_{f}∉M(p)}.

The metric associated with the API-based coupling of the module p, representing the degree of interaction between the module p and the other modules through the methods declared in the APIs I(p) is denoted by MII(p). The metric associated with the API-based coupling for the object-oriented program is denoted by MII(S).

$$MII ( p ) = \frac{\vert {⋃}_{i ∈ I ( p )} ExtCallRel ( i ) \vert}{\vert ExtCallRel ( p ) \vert}$$

$$MII ( S ) = \frac{1}{𝒫} {\sum }_{p ∈ 𝒫}^{ } MII ( p )$$

Where, P denotes a set of all the modules defined in the object-oriented program.

The calculated value for MII(S) lies in the range of 0 to 1. In the ideal state, the value of MII(S) is 1, which indicates that all the methods of the object-oriented program are called through their corresponding APIs. A value of 0 for the metric MII(S) indicates that the object oriented program has poor inter-module interaction.

b. Non-API Closedness Index (NC)

In an embodiment of the present invention, the metric associated with the API-based coupling of the module represents the non-API closedness of the module. The non-API closedness of the module is based on a set of pubic methods defined in the module. Further, the non-API closedness is based on a set of API methods and a set of non-API methods. The set of API methods includes the public methods of the set of public methods declared in the one or more APIs of the module. The set of non-API methods includes the public methods of the set of public methods not called by the other modules of the object-oriented program. In the ideal event, only the API methods are called by the other modules of the object-oriented program. In other words, the number of methods in the set of non-API methods is equal to the difference between the number of methods in the set of public methods and the number of methods in the set of API methods.

In an embodiment of the present invention, for a module p having one or more APIs denoted as the set I(p), the set of non-API methods is denoted as Mₙₐ(p), and the set of public methods defined in the module p is denoted by M_{pub}(p). For an API i of the set I(p), the set of methods declared in the API i is denoted by MN.

The metric associated with the API-based coupling of the module p representing the non-API closedness of the module p is denoted as NC(p). The metric representing the overall non-API closedness of the object-oriented program is denoted as NC(S).

$$NC ( p ) = \frac{\vert {M}_{na} ( p ) \vert}{\vert {M}_{pub} ( p ) - \{ {⋃}_{i ∈ I ( p )} M ( i ) \} \vert}$$

$$NC ( S ) = \frac{1}{𝒫} {\sum }_{p ∈ 𝒫} NC ( p )$$

### Where,

P denotes a set of all the modules defined in the object-oriented program, and I(p) denotes a set of APIs for module p.

The value of NC(S) lies in the range of 0 to 1. In the ideal state, the value of the metric is 1, which indicates that the methods of the set of non-API methods are not being called by the other modules of the object-oriented program.

There is a possibility that all the public methods M_{pub}(p) of module p are declared in the APIs. In such a case, the value of the metric is determined by the size of the object-oriented program. If the object-oriented program is small and a programmer considers all the public methods to constitute the API of the module p, NC(p) has a value 1 when both the numerator and the denominator are 0. On the other hand, in the case of large object-oriented programs for which only a subset of the public methods M_{pub}(p) constitutes the APIs of module p, NC(p) is 0 when the denominator is 0.

c. Not Programming Interface Index (NPII)

The module defines one or more classes that form one or more inheritance hierarchies. Each inheritance hierarchy has a root interface. In an ideal case, when a module A acts as a client to module B, module A accesses the functionalities of module B only through the root interfaces of the inheritance hierarchies of module B. The root interfaces include abstract classes and abstract methods. An abstract class is a class that cannot be instantiated but can be extended through inheritance. An abstract method is a method declared in the abstract class without an implementation. The abstract method can be overridden by a method defined in the extending class of the abstract class. This method is known as a concrete method. The concrete method provides the implementation of the abstract method.

In an embodiment of the present invention, the metric associated with the API-based coupling of the module is based on a set of abstract methods and a set of concrete methods. Each abstract method is called by at least one method of the one or more methods of the module. Each concrete method is called by at least one method of the one or more methods of the module and defined by a class, which is a part of an inheritance hierarchy.

In an embodiment of the present invention, the set of abstract methods called by a method m is denoted as AbsCallby (m).

AbsCallby(m)={m_{abs}|m_{abs}∈Callby(m)}

Where, Callby(m) denotes a set of methods called by method m, and
m_{abs} denotes an abstract method.

The set of concrete methods called by method m is denoted by InhConcCallby(m). The concrete methods are defined by classes, which are a part of an inheritance hierarchy of the module p.

InhConcCallby(m)={m_{conc}|m_{conc}∈Callby(m) [symbol] ∃_{c′∈}c(m_{conc}∈M(c′) [symbol] Anc(c′)≠θ}

Where, m_{conc} denotes a concrete method called by method m,
M(c′) denotes a set of methods declared in class c′, and
Anc(c′) denotes a set of ancestor classes of class c′.

A set of concrete methods called by method m that overrides the other methods of the object-oriented program is denoted by BadConcCallby(m).

BadConcCallby(m)={m′|m′∈InhConcCallby(m) [symbol] (DoesOvride(m′) [symbol] DoesImpl(m′))}

Where, DoesOvride(m′) is a predicate, which is true when method m′ overrides a method of the object-oriented program, and
DoesImpl(m′) is a predicate, which is true when method m′ is an implementation of an abstract method of the object-oriented program.

The metrics representing the extent of non-programming to interfaces for a module p, and the object-oriented program are denoted by NII(p) and NII(S), respectively.

$$AbsCallby ( p ) = {⋃}_{m ∈ M ( p )} AbsCallby ( m )$$

$$InhConcCallby ( p ) = {⋃}_{m ∈ M ( p )} InhConcCallby ( m )$$

$$BadConcCallby ( p ) = {⋃}_{m ∈ M ( p )} BadConcCallby ( m )$$

$$NPII ( p ) = \frac{\vert AbsCallby ( p ) \vert}{\vert AbsCallby ( p ) \vert + \vert InhConcCallby ( p ) \vert} + \frac{ψ \vert InhConcCallby ( p ) - BadConcCallby ( p ) \vert}{\vert AbsCallby ( p ) \vert + \vert InhConcCallby ( p ) \vert}$$

$$where$$

$$0 \leq ψ \leq 1 = ⊥ when AbsCallby ( p ) ⋃ InhConcCallby ( p ) = φ$$

$$NPII ( S ) = \frac{1}{\vert {𝒫}^{′} \vert} {\sum }_{p ∈ {𝒫}^{′}} NPII ( p ) = 1 if {𝒫}^{′} = φ$$

Where, M(p) denotes a set of all the methods defined in module p, and
P′ denotes a set of all the modules defined in the object-oriented program.

The value of NPII ranges from 0 to 1. The value of 1 indicates that only the abstract methods defined in the root interfaces of the inheritance hierarchies of the modules are accessed by other modules.

d. API Cohesiveness and Segregation (APIU)

In an embodiment of the invention, the metric associated with the API-based coupling of the module measures the extent to which the S-APIs of the module are cohesive and segregated. The S-APIs must be cohesive with respect to their functionalities and segregated from the other S-APIs of the module with respect to their use. The metric is based on a set of modules and a set of methods. Each module of the set of modules calls at least one method declared in the APIs of the module. Each method of the set of methods is declared in at least one API of the module and is called by at least one module of the set of modules.

In an embodiment of the present invention, I^{S}(p) denotes a set of all S-APIs of module p. For an S-API i of the set I^{S}(p), M(i) denotes a set of methods declared in the S-API i. The set of other modules calling at least one method of the set M(i) is denoted as CallingMode(i).

CallingMod(i)={p∈′P|∃ₘ_{_{f}}_{∈M(p)}∃ₘ_{ₜ}_{∈M(i)}Call(m_{f},mₜ) [symbol] p≠p′}

The set of methods in M(i) that is called by p′ [symbol] Calling Mod(i) is denoted as M(i, p′)

M(i,p′)={m∈M(i) |p′∈CallingMod(i) [symbol] ∃ₘ_{_{f}}_{∈M(p′)}Call(m_{f},m)}

Where, M(i) denotes a set of methods declared in S-API I, and
M(p′) denotes a set of methods declared in the module p′.

The cohesiveness of the S-API i is denoted as APIUC(i). The overall cohesiveness of module p is denoted as APIUC(p).

$$APIUC ( i ) = \frac{{\sum }_{{p}^{′} ∈ Calling Mod ( i )} \vert M ( i , {p}^{′} ) \vert}{\vert Calling Mod ( i ) \vert \times \vert M ( i ) \vert}$$

$$APIUC ( p ) = \frac{{\sum }_{i ∈ {I}^{S} ( p )} ( α ( i ) \times APIUC ( i ) )}{\vert {I}^{S} ( p ) \vert}$$

Where, α(i) denotes a weight associated with the S-API i. In an embodiment of the present invention, the weight is determined by the size of the S-API i.

$$α ( i ) = \frac{\vert M ( i ) \vert}{\vert {⋃}_{{i}_{j} ∈ {I}^{S} ( p )} M ( {i}_{j} ) \vert}$$

For a module p, a set of cohesive interfaces is denoted as APIUCSet(p).

APIUCSet(p)={i∈I^{S}(p)|APIUC(i)≧λ}

Where, λ, is a user-defined threshold that determines whether S-API is cohesive. The degree of segregation of client modules with respect to a cohesive S-API is denoted by APIUS(p).

$$\begin{matrix}APIUS ( p ) = 1 - ( \frac{\vert {⋃}_{{i}_{1} , {i}_{2} ∈ APIUCSet ( p )} CallingMod ( {i}_{1} ) ⋂ CallingMod ( {i}_{2} ) \vert}{\vert {⋃}_{i ∈ APIUCSet ( p )} CallingMod ( i ) \vert} ) \\ = 0 if APIUCSet ( p ) = φ\end{matrix}$$

The metric to measure the extent to which the S-APIs of the module p are cohesive and segregated is denoted as APIU(p). The metric to measure the extent to which the S-APIs of all the modules of the object-oriented program are cohesive and segregated is denoted as APIU(S).

$$APIU ( p ) = \frac{APIUS ( p ) + APIUC ( p )}{2}$$

$$APIU ( S ) = \frac{1}{\vert 𝒫 \vert} {\sum }_{p ∈ 𝒫} APIU ( p )$$

The values of APIU(p) and APIU(S) lie between 0 and 1. The value of 1 indicates the best case in which the S-APIs are cohesive and segregated to the maximum extent.
2. Metrics Associated with Inheritance-Based Coupling of the Module

Inheritance is a property of object-oriented programming. Using inheritance, a class can be defined in such a way that it derives attributes and methods from the other classes of the object-oriented program. For example, a software product can be launched with customization functionality. The customization functionality enables the buyer of the software product to extend the functionality of the software product by creating new classes derived from the classes of the software product. If a new class defined by the buyer is defined in module A and the new class is derived from a base class defined in module B, module A and module B become inter-dependent. If the new class inherits information declared in the APIs of module A, the base class can be changed without affecting the functionality of the new class in module B, and vice versa. However, if this is not true, making a change in the base class affects the functionality of the new class in module B, and vice versa. This is known as fragile base class problem. Therefore, metrics have been defined to measure the interdependence, induced by inheritance, between the modules of the object-oriented program.

In an embodiment of the present invention, there are two metrics associated with the inheritance-based coupling of the module. They are Base Class Fragile Index (BCFI) and Inheritance-Based Inter-Module Coupling Metric. The calculation of these metrics has been further explained below in detail.

a. Base Class Fragile Index (BCFI)

In an embodiment of the present invention, the metric associated with the inheritance-based coupling of the module measures the degree to which the fragile base class problem is present in the object-oriented program. The metric is based on a set of concrete methods and the number of times each concrete method is overridden outside a module defining the concrete method. Each concrete method of the set of concrete methods is called by at least one method of the one or more methods of the module and defined by the at least one class or an ancestor of the at least one class.

In an embodiment of the invention, for a class c of a module p, the set of concrete methods inherited from the ancestor classes of class c, and not overridden in the class c, is denoted as M_{anc}(c).

M_{anc}(c)={m′_{conc}∈M(c′)|c′∈Anc(c) [symbol] (∀_{m∈M(c)} [symbol] Ovride(m′_{conc},m))}

Where, m′_{conc} is a concrete method,
M(c′) denotes a set of methods defined in class c′,
Anc(c) denotes a set of ancestor classes of class c, and
Overide(m′_{conc},m) is a predicate, which is true when concrete method m′_{conc} is overridden by method m of class c.

For a method m of class c, the set of concrete methods called by m, and either defined in class c or inherited by class c, is denoted as UpCallby(m).

UpCallby(m)={m′_{conc}|Call(m,m′_{conc}) [symbol] (m′_{conc}∈M(c) [symbol] m′_{conc}∈M_{anc}(c))}

Where, Call(m, m′_{conc}) is a predicate, which is true when method m calls concrete method m′_{conc},
M(c) denotes the methods declared in class c, and
M anc(c) denotes a set of methods defined in the ancestor classes of class c.

For method m′, base class violation BCVᵢₒ(m′) indicates the number of times method m′ is overridden out of the module in which m′ is defined.

$$\begin{matrix}BCVio ( {m}^{′} ) = \frac{\vert \{ {m}_{o}^{′} ∈ Ovride ( {m}^{′} ) \vert Module ( {m}^{′} ) \neq Module ( {m}_{o}^{′} ) \}}{\vert Ovride ( {m}^{′} ) \vert} \\ = 0 when Ovride ( {m}^{′} ) = 0 /\end{matrix}$$

Where, Overide(m′) denotes a set of methods that overrides method m′,
Module(m) denotes a module that defines method m′, and
Module(mₒ′) denotes a module that defines method mₒ′.

BCVio is calculated for all the concrete methods of the set UpCallby(m) for method m. BCV Max(m) is the maximum of BCVio values for all the concrete methods of the set UpCallby(m).

$$\begin{matrix}BCV Max ( m ) = {max}_{{m}^{′} ∈ UpCallby ( m )} \{ BCVio ( {m}^{′} ) \} \\ = 0 when UpCallby ( m ) = 0 /\end{matrix}$$

At the level of class c, BCV Max(c) is the maximum of BCV Max(m) for all the methods defined in class c.

BCV Max(c)=max_{m∈M(c)}BCV Max(m)

At the module level, for module p, the set of classes defining at least one method with the non-empty UpCallby set is denoted as BCVSet(p).

BCV Set(p)={c∈Cₚ|∃_{m∈M(c)}(UpCallby(m)≠θ)}

The metric to measure the base class fragility of module p is denoted by BCFI(p).

$$BCFI ( p ) = 1 - \frac{1}{\vert BCV Set ( p ) \vert} {\sum }_{c ∈ Cp} BCV Max ( c )$$

$$BCFI ( S ) = \frac{1}{\vert {𝒫}^{′} \vert} {\sum }_{p ∈ {𝒫}^{′}} BCFI ( p ) , \\ where$$

$$\begin{matrix}{𝒫}^{′} = \{ {p}^{′} ∈ 𝒫 \vert BCV Set ( p ) \neq 0 / \} \\ = 1 when {𝒫}^{′} = 0 /\end{matrix}$$

The value of BCFI(p) ranges from 0 to 1. The value of 1 indicates the best case where the problem of base class fragility does not exist. On the other hand, the value 0 indicates the worst case. The base class violation for the object-oriented program denoted as BCFI(S) is the average of BCFI(p) for all the modules in the object-oriented program. The value of BCFI(S) ranges from 0 to 1. The value of 1 indicates the best case where the problem of base class fragility does not exist. On the other hand, the value 0 indicates the worst case.

b. Inheritance-Based Inter-Module Coupling Metric

In an embodiment of the present invention, the metric associated with the API-based coupling of the module represents the inheritance-based coupling of the module with the other modules of the object-oriented program. The metric is based on a set of other modules, a first set of classes and a second set of classes. Each module of the set of other modules defines at least one class, which is derived from a class of the one or more classes of the module. Each class of the first set of classes is derived from a class of the one or more classes of the module. Further, each class of the second set of classes is a class of the one or more classes and derived from a class defined in the other modules of the object-oriented program. In the ideal event, none of the classes defined in a module is derived from the classes defined outside the module.

In an embodiment of the present invention, for a module p, the number of modules in the set of other modules that has at least one class derived from a class of module p is denoted as IC₁(p).

$$\begin{matrix}{IC}_{1} ( p ) = 1 - \frac{\vert \{ {p}^{′} ∈ 𝒫 \vert {∃}_{d ∈ C ( {p}^{′} )} {∃}_{c ∈ C ( p )} ( Chld ( c , d ) ⋀ p \neq {p}^{′} ) \} \vert}{\vert 𝒫 \vert - 1} \\ = 1 when \vert 𝒫 \vert = 1\end{matrix}$$

Where, p′ is a module of the object-oriented program,
C(p) denotes the set of all classes defined in module p,
C(p′) denotes the set of all classes defined in module p′, and
Chld(c,d) is a predicate, which is true when class d is a child of class c.

The number of classes in the first set of classes that is derived from the classes of module p and defined in other modules is denoted as IC₂(p).

$$\begin{matrix}{IC}_{2} ( p ) = 1 - \frac{\vert \{ d ∈ C \vert {∃}_{c ∈ C ( p )} ( Chld ( c , d ) ⋀ Module ( d ) \neq p ) \} \vert}{\vert C - C ( p ) \vert} \\ = 1 when \vert 𝒫 \vert = 1\end{matrix}$$

Where, Module(d) is a module that defines class d, and C denotes the set of all classes in the object-oriented program.

The number of classes in the second set of classes that is defined in module p and derived from classes defined in other modules is denoted as IC₃(p).

$${IC}_{3} ( p ) = 1 - \frac{\vert \{ c ∈ C ( p ) \vert {∃}_{d ∈ Par ( c )} ( Module ( d ) \neq p ) \} \vert}{\vert C ( p ) \vert}$$

Where, Par(c) denotes the set of ancestor classes of class c.

The metric representing the inheritance-based coupling of the module p is denoted as IC(p). At the level of the object-oriented program, the metric is denoted as IC(S). The values of the metrics lie in the range of 0 to 1. A value of 1 represents that module p is not coupled, based on inheritance, i.e., no class defined in module p is extended by a class defined in the other modules of the object-oriented program. On the other hand, a value of 0 indicates that module p is coupled to the other modules of the object-oriented program.

$$IC ( p ) = min ( {IC}_{1} , {IC}_{2} , {IC}_{3} )$$

$$IC ( S ) = \frac{1}{\vert 𝒫 \vert} {\sum }_{p ∈ 𝒫} IC ( p )$$

3. Metrics Associated with Association-Based Coupling of the Module

In the object-oriented program, a class defined in module A can access another class defined in module B as an attribute or a parameter in method definitions. This results in a dependency between module A and module B. The metric associated with the association-based coupling measures the degree of this dependency.

In an embodiment of the present invention, the metric associated with the association-based coupling of the module is based on a set of other modules of the one or more modules, a first set of classes and a second set of classes. Each module of the set of other modules includes at least one class that uses at least one class of the module as an attribute or a parameter in method definitions. Each class of the first set of classes is defined in a module of the set of other modules and uses at least one class defined in the module as an attribute or a parameter in its method definitions. Further, each class of the second set of classes is defined in the module and uses at least one class defined in other modules as an attribute or a parameter in its method definitions.

In an embodiment of the present invention, for a module p of the object-oriented program, the number of modules in the set of other modules is denoted as AC₁(p).

$$\begin{matrix}{AC}_{1} ( p ) = 1 - \frac{\vert \{ {p}^{′} ∈ 𝒫 \vert {∃}_{c ∈ C ( {p}^{′} )} {∃}_{d ∈ C ( p )} ( uses ( c , d ) ⋀ p \neq {p}^{′} ) \} \vert}{\vert 𝒫 \vert - 1} \\ = 1 when \vert 𝒫 \vert = 1\end{matrix}$$

Where, uses(c,d) is a predicate, which is true when class c uses class d, i.e., a method defined in class c either directly calls or implements a method defined in class d or reads/writes an attribute defined for class d.
C(p) and C(p′) are sets of classes defined in modules p and p′, respectively, and
P denotes the set of modules of the object-oriented program.

The number of classes in the first set of classes for the module p is denoted as AC₂(p).

$$\begin{matrix}{AC}_{2} ( p ) = 1 - \frac{\vert \{ c ∈ C \vert {∃}_{d ∈ C ( p )} ( uses ( c , d ) ⋀ Module ( c ) \neq p ) \} \vert}{\vert C - C ( p ) \vert} \\ = 1 when \vert 𝒫 \vert = 1\end{matrix}$$

Where, Module(c) is a module that defines class c, and
C denotes the set of all the classes defined in the object-oriented program.

The number of classes in the second set of classes for the module p is denoted as AC₃(p).

$${AC}_{3} ( p ) = 1 - \frac{\vert \{ c ∈ C ( p ) \vert {∃}_{d ∈ uses ( c )} ( Module ( d ) \neq p ) \} \vert}{\vert C ( p ) \vert}$$

Where, uses(c) denote the set of classes that use class d in its method definitions.

The metric associated with the association-based coupling of the module p is denoted as AC(p). At the level of the object-oriented program, the metric is denoted as AC(S).

$$AC ( p ) = min ( {AC}_{1} , {AC}_{2} , {AC}_{3} )$$

$$AC ( S ) = \frac{1}{\vert 𝒫 \vert} {\sum }_{p ∈ 𝒫} AC ( p )$$

The values of these metrics lie in the range of 0 to 1. The value of 0 indicates that the object oriented program has high degree of association-based coupling. On the other hand, the value of 1 indicates that association based coupling does not exist in the object oriented program. For example, there are various object oriented systems that do not have any association based coupling and compile type dependency at all. All dependencies are injected at runtime. The value of AC for such systems would be closer to 1.

4. Metrics Associated with the Size of the Module

During the development of a software product, good programming practice is to keep track of the size variation among classes in a module and among modules in the object-oriented program. A class that is disproportionately larger than the other classes of the module indicates that the class is not cohesive, i.e., the class does not have a single functionality. In this case the class can be replaced by classes small in size that individually offer a single functionality to the software product. Similarly, a module disproportionately larger than the other modules of the object-oriented program can be disintegrated into small modules.

In an embodiment of the present invention, there are three metrics associated with the size-based coupling of the module. The three metrics are index to measure size variability in number of classes of modules (MU(S)), index to measure class size variability by counting number of methods in classes (CUm (S)) and index to measure class size variability by counting number of lines of code in classes (CUi (S)). The calculation of these metrics has been further explained below in detail.

a. Index to Measure Size Variability in Number of Classes of Modules (MU)

In an embodiment of the present invention, the metric based on the size of the module represents the variation in the number of classes in the modules of the object-oriented program. The metric is based on the average size of the at least one module. Further, the metric is based on the standard deviation of the average size. The size of a module is determined by the number of classes in the module.

In an embodiment of the present invention, the metric representing the variation in the number of classes in the modules is denoted as MU (S). The value of the metric lies in the range of 0 to 1. The value of 1 indicates that all the modules of the object oriented-program implement the same number of classes.

$$MU ( S ) = \frac{{μ}_{p}}{{μ}_{p} + {σ}_{p}}$$

Where, μₚ denotes the average size of the module p, and σₚ denotes the standard deviation of the average size.
b. Index To Measure Class Size Variability by Counting Number of Methods in Classes (CUₘ)

In an embodiment of the present invention, the metric associated with the size of the module measures the size variability among the one or more classes of the module. The metric is based on the average size of the one or more classes of the module. Further, the metric is based on the standard deviation of the average size. The average size of the classes is determined by the number of methods defined in the one or more classes.

In an embodiment of the present invention, the metric representing the size variability among the one or more classes of the module p is denoted as CUₘ(S). The value of the metric lies in the range of 0 to 1. The value of 1 indicates that all the classes of the module are of the same size in terms of the number of methods defined in the classes.

$${CU}_{m} ( S ) = \frac{1}{\vert 𝒫 \vert} {\sum }_{p ∈ 𝒫} \frac{{μ}_{m} ( p )}{{μ}_{m} ( p ) + {σ}_{m} ( p )}$$

Where, μₘ(p) denotes the average size of the module p, and σₘ(p) denotes the standard deviation of the average size.
c. Index to Measure Class Size Variability by Counting Number of Lines of Code in Classes

In an embodiment of the present invention, the metric associated with the size of the module measures the size variability among the one or more classes of the module. The metric is based on the average size of the one or more classes of the module. Further, the metric is based on the standard deviation of the average size. The average size of the classes is determined by the number of lines of code in the one or more classes.

In an embodiment of the present invention, the metric representing the size variability among the one or more classes of the module p is denoted as CUᵢ(S). The value of the metric lies in the range of 0 to 1. The value of 1 indicates that all the classes of the module are of the same size in terms of the number of lines of code in the classes.

$${CU}_{i} ( S ) = \frac{1}{\vert 𝒫 \vert} {\sum }_{p ∈ 𝒫} \frac{{μ}_{i} ( p )}{{μ}_{l} ( p ) + {σ}_{l} ( p )}$$

Where, μₗ(p) denotes the average size of the module p, and σₗ(p) denotes the standard deviation of the average size.
5. Metrics Associated with the State Access-Based Coupling of the Module

The state of a class defined in a module of the object-oriented program is determined by the attributes declared in the class. The attributes that are not declared as private can be accessed by the other classes of the object-oriented program. When an attribute of a class defined in module A is accessed by another class defined in module B, module B directly accesses the state of module A. This results in inter-module access of state.

The metric associated with the state access-based coupling of the module measures the extent to which the state of a class in a module is accessed by classes of other modules. The metric is based on a set of other modules, a first set of attributes, a second set of attributes and a set of classes. Each module of the set of other modules accesses at least one attribute of the one or more attributes defined in a class of the one or more classes of the module. Each attribute of the first set of attributes is defined in a class of the one or more classes and accessed by the classes defined in the other modules of the object-oriented program. Each attribute of the second set of attributes is defined in a class of the module and accessed by the other classes of the module. Further, each class of the set of classes is defined in the module and accesses at least one class defined in the module. In an ideal situation, the state of any class defined in the module is not accessed by a class defined outside the module.

In an embodiment of the present invention, for a class c defined in the module p, the first set of attributes that is accessed by modules other than module p is denoted as InterStateAcc1(c).

InterStAcc1(c)={a∈A(c)|∃_{d∈uses(a)}Module(c)≠Module(d)}

Where, a denotes an attribute of class c,
A(c) denotes the set of all attributes defined in class c,
uses(a) denotes the set of modules that uses the attribute a,
Module(c) denotes a module that defines class c and
Module(d) denotes a module that defines class d.

The set of other modules that accesses the state of class c of the module p is denoted as InterStAcc2(c).

InterStAcc2(c)={p′∈P|∃_{a∈A(c)}∃_{d∈C(p′)}(Module(c)≠p′ [symbol] used(a,d))}

Where, p′ is a module of the object-oriented program,
C(p′) denotes the set of classes defined in module p′, and
used(a,d) is a predicate, which is true when class a uses class d.

The second set of attributes for class c that is accessed by the classes defined in module p is denoted as IntraStAcc1(c).

IntraStAcc1(c)={a∈A(c)|∃_{d∈used(a)}Module(c)=Module(d)}

The set of classes that resides in the same module as class c, i.e., module p and accesses at least one attribute of class c is denoted as IntraStAcc2(c).

IntraStAcc2(c)={d∈C(p)|∃_{a∈A(c)}(Module(c)=Module(d) [symbol] used(a,d))}

The metrics, representing the state access violation with respect to class c, module p and the object-oriented program are denoted as SAVI(c), SAVI(p) and SAVI(S), respectively. SAVI(c) is the weighted average of the four state access cases explained above. The values of these metrics lie in the range of 0 to 1.

$$SAVI ( c ) = 1 - ( \begin{matrix}{ω}_{3} \frac{\vert InterStAcc 1 ( c ) \vert}{\vert A ( c ) \vert} + \\ {ω}_{2} \frac{\vert InterStAcc 2 ( c ) \vert}{\vert 𝒫 \vert} + \\ {ω}_{3} \frac{\vert IntraStAcc 1 ( c ) \vert}{\vert A ( c ) \vert} + \\ {ω}_{4} \frac{\vert IntraStAcc 2 ( c ) \vert}{\vert C ( p ) \vert}\end{matrix} )$$

$$SAVI ( p ) = \frac{1}{\vert {C}_{p} \vert} {\sum }_{c ∈ {C}_{p}} SAVI ( c )$$

$$SAVI ( S ) = \frac{1}{\vert 𝒫 \vert} {\sum }_{p ∈ 𝒫} SAVI ( p )$$

$$Where , \\ {\sum }_{i = 1}^{4} {ω}_{i} = 1$$

6. Metrics Associated with the Use of the Module

During the development of a software product, classes that are used together must be packaged/defined in a single module. To find classes that are used together, the present invention uses a frequent-item set mining algorithm called Apriori. This algorithm can be employed to find frequently occurring sets of items in a large database of items. In an embodiment of the present invention, each class in the module is considered an item.

The metric associated with the use of the module measures the extent to which classes being used together are packaged together in a module. The metric is based on a set of classes and a set of modules. Each class of the set of classes is used together in the object-oriented program. Further, each module of the set of modules defines at least one class of the set of classes. In the ideal event, all the classes used together are defined in a module.

In an embodiment of the present invention, C denotes the set of all classes defined in the object-oriented program. β(S) denotes a power set of all the potential use co-occurrences of all the classes. The set of classes that can be used together is denoted as s [symbol] β(S). Let (s) denote the probability of the set of classes s being used together in a module. Further, S is a discrete random variable having a value from β(S).

Let q(p) be the probability of selecting a module from the set of modules denoted as P,

where P denotes the set of all modules defined in the object-oriented program. Further, P is a discrete random variable having a value from the set P. The probability to measure the extent to which a set S chosen randomly from the power set β(S) can tell
about the composition of a module P is denoted as q(P|S).

$$ϱ ( P \vert S ) = \frac{ϱ ( P ⋂ S )}{ϱ ( S )}$$

In an example, suppose an element s of the power set β(S) includes 10 classes such that S={C1, C2, C3 . . . C10}. These 10 classes have been used together. Out of these 10 classes, C1 and C2 belong to module p1, C3-C5 belong to module p2, and C6-C10 belong to module p3. Therefore, using the formula above, we have:

$$ϱ ( P = {p}_{1} \vert S = s ) = \frac{2}{10} , ϱ ( P = {p}_{2} \vert S = s ) = \frac{3}{10}$$

$$ϱ ( P = {p}_{3} \vert S = s ) = \frac{5}{10} .$$

The mutual information content between the set of classes used together and the set of classes packaged/defined together is denoted as I(P;S).

I(P;S)=H(P)−H(P|S)

Where, H(P) is entropy associated with all the modules of the object-oriented program and H(P|S) is the conditional entropy of all the modules with respect to the different set of classes that can be used together.

$$H ( P ) = - {\sum }_{p ∈ 𝒫} ϱ ( p ) log ϱ ( p )$$

$$H ( P \vert S ) = - {\sum }_{s ∈ ℬ ( ɛ )} ϱ ( s ) {\sum }_{p ∈ 𝒫} ϱ ( p \vert s ) log ϱ ( p \vert s )$$

In the ideal event, the value of mutual information content between the set of classes used together and the modules should be the maximum. In such an event, H(P|S) is zero.

The metric to measure the extent to which the classes used together are packaged together is denoted as CReuM(S).

$$CReuM ( S ) = \frac{I ( P ; S )}{H ( P )}$$

When the value of CReuM(S) is 0 (worst case), all the classes of the object-oriented program are defined in a single module.

At step 104, at least one calculated metric is analyzed, based on a pre-defined threshold value. In an embodiment of the present invention, the pre-defined threshold value can be a single value. In another embodiment of the present invention, the pre-defined threshold value can be a range of values.

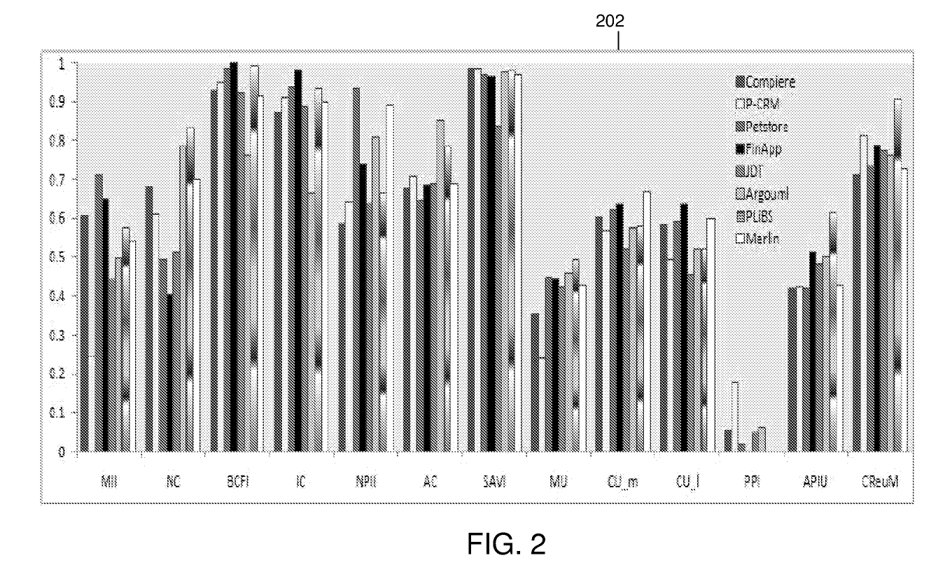

The calculated value of the metric is compared to the corresponding pre-defined threshold. For example, the value of the metric MII(p) is compared to the range 0 to 1. When the value of MII(p) is equal to 0.8, it can be inferred that module p is near to the ideal state of modularity. On the other hand, when the value of the metric MII(p) is 0.1, it can be inferred that module p has poor inter-module interaction. Similarly, all the other metrics calculated at step 102 can be analyzed to assess the modularity of the object-oriented program. In an embodiment of the present invention, the results obtained from the analysis of the metrics are presented to the users in the form of graphical reports such as charts, tables, and the like. It may be apparent to any person skilled in the art that there may be various other forms of graphical reports. An exemplary chart 202 depicting the results of the analysis is shown in FIG. 2. In chart 202, the x-axis depicts the various metrics described above, and the y-axis depicts the calculated values of these metrics for software systems such as Compiere, P-CRM, Pet-Store, and FinApp. The value of BCFI for FineApp is 1, which indicates that the problem of base class fragility does not exist in. FineApp.

In an embodiment of the present invention, all the metrics described above are analyzed. In another embodiment of the present invention, metrics selected by a user are analyzed.

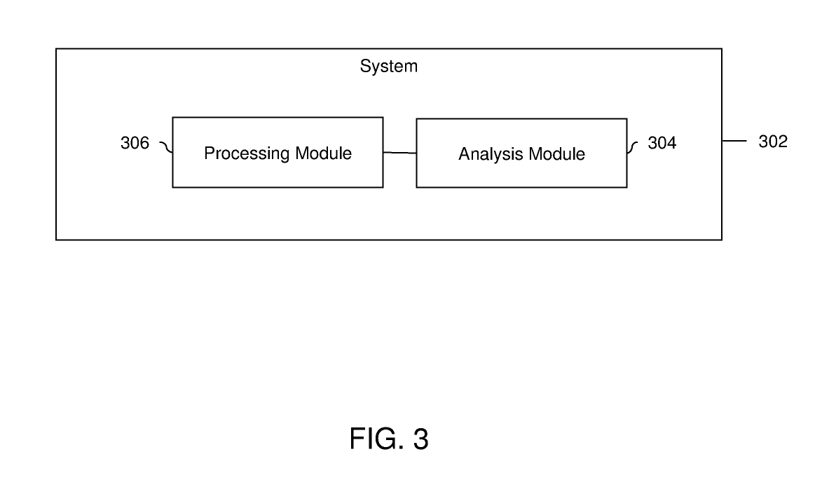

FIG. 3 is a block diagram illustrating a system 302 configured to assess the modularity of an object-oriented program. The object-oriented program is associated with a plurality of properties. Various examples of the properties include, but are not limited to, inheritance, polymorphism, abstraction, containment, and encapsulation.

As explained earlier, the object-oriented program includes a plurality of modules. At least one module of the plurality of modules includes one or more classes and one or more APIs. Further, at least one class of the one or more classes includes one or more methods and one or more attributes.

System 302 includes a processing module 304 and an analysis module 306.

Processing module 304 calculates at least one metric for each of the at least one module. Each of the at least one metric is based on a property of the plurality of properties. In an embodiment of the present invention, processing module 304 calculates the metrics associated with one of API-based coupling of the module, inheritance-based coupling of the module, association-based coupling of the module, state access-based coupling of the module, size of the module and use of the module. The calculation of the at least one metric has been explained in detail in conjunction with FIG. 1 at step 102.

Analysis module 306 analyzes the at least one calculated metric, based on a pre-defined threshold value. The analysis of the at least one metric has been explained in conjunction with FIG. 1 at step 104. Further, analysis module 306 generates graphical reports to present the results obtained from the analysis of the metrics to the users. An exemplary chart generated by analysis module 306 has been explained in conjunction with FIG. 2.

In an embodiment of the present invention, analysis module 306 analyzes all the metrics described above. In another embodiment of the present invention, analysis module 306 analyzes metrics selected by a user.

In various embodiments of the invention, processing module 304 and analysis module 306 can be implemented in the form of hardware, software, firmware and/or combinations thereof.

The process, system and computer program product described above have a number of advantages. The process enables calculation of metrics to quantitatively measure the modularity of the object-oriented program. Further, these metrics are calculated at the level of modules and based on various properties of the object-oriented program, such as interdependence induced among the modules due to properties such as inheritance, polymorphism, abstraction and containment. Since the metrics are calculated at the level of modules, the present invention overcomes the disadvantages of calculating the metrics at the level of classes. Furthermore, the system displays the calculated values of the metrics in the form of graphical reports to the users. These graphical reports enable the users to monitor the modularity of the object-oriented program and identify the reasons for degradation in modularity.

The system for assessing the modularity of an object oriented program, as described in the present invention or any of its components, may be embodied in the form of a computer system. Typical examples of a computer system include a general-purpose computer, a programmed microprocessor, a micro-controller, a peripheral integrated circuit element, and other devices or arrangements of devices that are capable of implementing the steps that constitute the method of the present invention.

The computer system comprises a computer, an input device, a display unit and the Internet. The computer further comprises a microprocessor, which is connected to a communication bus. The computer also includes a memory, which may include Random Access Memory (RAM) and Read Only Memory (ROM). The computer system also comprises a storage device, which can be a hard disk drive or a removable storage drive such as a floppy disk drive, an optical disk drive, etc. The storage device can also be other similar means of loading computer programs or other instructions to the computer system. The computer system also includes a communication unit, which enables the computer to connect to other databases and the Internet through an Input/Output (I/O) interface. The communication unit also enables the transfer as well as reception of data from other databases. The communication unit may include a modem, an Ethernet card, or any similar device which enable the computer system to connect to databases and networks such as Local Area Network (LAN), Metropolitan Area Network (MAN), Wide Area Network (WAN) and the Internet. The computer system facilitates inputs from a user through an input device, accessible to the system through an I/O interface.

The computer system executes a set of instructions that is stored in one or more storage elements, to process the input data. The storage elements may also hold data or other information as desired. The storage element may be in the form of an information source or a physical memory element present in the processing machine.

The present invention may also be embodied in a computer program product to assess the modularity of the object-oriented program. The computer program product includes a computer-usable medium having a set of program instructions comprising a program code to assess the modularity of the object-oriented program. The set of instructions may include various commands that instruct the processing machine to perform specific tasks such as the steps that constitute the method of the present invention. The set of instructions may be in the form of a software program. Further, the software may be in the form of a collection of separate programs, a program module with a large program or a portion of a program module, as described in the present invention. The software may also include modular programming in the form of object-oriented programming. The processing of input data by the processing machine may be in response to user commands, results of previous processing or a request made by another processing machine.

While the preferred embodiments of the invention have been illustrated and described, it will be clear that the invention is not limit to these embodiments only. Numerous modifications, changes, variations, substitutions and equivalents will be apparent to those skilled in the art without departing from the spirit and scope of the invention, as described in the claims.

What is claimed is:

1. A process for assessing modularity of an object oriented program, a plurality of properties being associated with the object oriented program, the object oriented program comprising a plurality of modules, at least one module of the plurality of modules comprising one or more classes and one or more application programming interfaces (APIs), at least one class of the one or more classes comprising one or more attributes and one or more methods, the process comprising:
a. calculating at least one metric for each of the at least one module, wherein each of the at least one metric is associated with one property of the plurality of properties associated with the object oriented program; and
b. analyzing the at least one calculated metric based on a pre-defined threshold value, wherein the analysis facilitates the assessment of the modularity of the object oriented program.

2. The process according to claim 1, wherein the one property of the plurality of properties is one of API based coupling of the at least one module, inheritance based coupling of the at least one module, association based coupling of the at least one module, state access based coupling of the at least one module, size of the at least one module and usage of the at least one module.

3. The process according to claim 1, further comprising generating one or more graphical reports based on the analysis of the at least one calculated metric.

4. The process according to claim 2, wherein the at least one metric associated with the API based coupling of the at least one module is based on a first set of external calls and a second set of external calls, each of the first set of external calls being made to a subset of the one or more methods, the subset of the one or more methods being declared in at least one API of the one or more APIs of the at least one module, each of the second set of external calls being made to the one or more methods.

5. The process according to claim 2, wherein the at least one metric associated with the API based coupling of the at least one module is based on a set of public methods of the one or more methods, a set of non-API methods of the set of public methods and a set of API methods of the set of public methods, wherein each method of the set of non-API methods is not called by other modules of the object oriented program, each method of the set of API methods being declared in at least one API of the one or more APIs of the at least one module.

6. The process according to claim 2, wherein the at least one metric associated with the API based coupling of the at least one module is based on a set of abstract methods and a set of concrete methods, each abstract method of the set of abstract methods being defined in a class of the object oriented program and called by at least one method of the one or more methods, each concrete method of the set of concrete methods being defined in a class of an inheritance hierarchy and called by at least one method of the one or more methods.

7. The process according to claim 2, wherein the at least one metric associated with the API based coupling of the at least one module is based on a set of modules of the plurality of modules and a set of methods, wherein each module of the set of modules calls at least one method of one API of the one or more APIs, each method of the set of methods being called by at least one module of the set of modules, wherein each method of the set of methods is declared in the one API.

8. The process according to claim 2, wherein the at least one metric associated with the inheritance based coupling of the at least one module is based on a set of concrete methods and number of times each concrete method of the set of concrete methods is overridden, wherein each concrete method of the set of concrete methods is overridden outside a module of the plurality of modules defining the concrete method, each concrete method of the set of concrete methods being called by at least one method of the one or more methods, each concrete method of the set of concrete methods being defined by at least one of the at least one class and at least one of ancestor classes of the at least one class.

9. The process according to claim 2, wherein the at least one metric associated with the inheritance based coupling of the at least one module is based on a set of other modules of the plurality of modules, a first set of classes and a second set of classes, each module of the set of other modules having at least one class derived from at least one class of the one or more classes of the at least one module, each class of the first set of classes being derived from at least one class of the one or more classes of the at least one module, each class of the second set of classes is a class of the one or more classes and derived from at least one class of at least one module of the other modules.

10. The process according to claim 2, wherein the at least one metric associated with the association based coupling of the at least one module is based on a set of other modules of the plurality of modules, a first set of classes and a second set of classes, each module of the set of other modules having at least one class using at least one class of the one or more classes as a parameter in method definitions, each class of the first set of classes using at least one class of the one or more classes as a parameter in method definitions, each class of the second set of classes using at least one class of at least one module of other modules as a parameter in method definitions, wherein each class of the second set of classes is a class of the one or more classes.

11. The process according to claim 2, wherein the at least one metric associated with the size of the at least one module is based on an average size of the at least one module and standard deviation of the average size of the at least one module, the average size of the at least one module being associated with the number of classes in the at least one module.

12. The process according to claim 2, wherein the at least one metric associated with the size of the at least one module is based on an average size of the one or more classes of the at least one module and standard deviation of the average size of the one or more classes, the average size of the one or more classes being associated with the number of methods in each of the one or more classes.

13. The process according to claim 2, wherein the at least one metric associated with the size of the at least one module is based on an average size of the one or more classes of the at least one module and standard deviation of the average size of the one or more classes, the average size of the one or more classes being associated with the number of lines of code in each of the one or more classes.

14. The process according to claim 2, wherein the at least one metric associated with the state access based coupling of the at least one module is based on a first set of attributes, a set of other modules, a second set of attributes and a set of classes, each attribute of the first set of attributes being an attribute of the one or more attributes and being accessed by at least one class of at least one module of other modules, each module of the set of other modules accessing at least one attribute of the one or more attributes, each attribute of the second set of attributes being defined in at least one class of the one or more classes and being accessed by other classes of the one or more classes, each class of the set of classes being a class of the one or more classes and accessing at least one attribute of other classes of the one or more classes.

15. The process according to claim 2, wherein the at least one metric associated with the usage of the at least module is further based a set of classes and a set of modules of the plurality of modules, each class of the set of classes being used together in the object oriented program, wherein each module of the set module defines at least one class of the set of classes.

16. A system configured to assess modularity of an object oriented program, a plurality of properties being associated with the object oriented program, the object oriented program comprising a plurality of modules, at least one module of the plurality of modules comprising one or more classes and one or more application programming interfaces (APIs), at least one class of the one or more classes comprising one or more attributes and one or more methods, the system comprising:
a. a processing module is configured for calculating at least one metric for each of the at least one module, wherein the each of the at least one metric is associated with one property of the plurality of properties associated with the object oriented program; and
b. an analysis module configured for analyzing the at least one calculated metric based on a pre-defined threshold value, wherein the analysis facilitates the assessment of the modularity of the object oriented program.

17. The system according to claim 16, wherein the one property of the plurality of properties is one of API based coupling of the at least one module, inheritance based coupling of the at least one module, association based coupling of the at least one module, state access based coupling of the at least one module, size of the at least one module and usage of the at least one module.

18. The system according to claim 16, wherein the analysis module is further configured for generating one or more graphical reports based on the analysis of the at least one calculated metric.

19. The system according to claim 17, wherein the processing module is further configured for calculating the at least one metric associated with the API based coupling of the at least one module, the at least one metric being based on a first set of external calls and a second set of external calls, each of the first set of external calls being made to a subset of the one or more methods, of the subset of the one or more methods being declared in at least one API of the one or more APIs of the at least one module, each of the second set of external calls being made to the one or more methods.

20. The system according to claim 17, wherein the processing module is further configured for calculating the at least one metric associated with the API based coupling of the at least one module, the at least one metric being based on a set of public methods of the one or more methods, a set of non-API methods of the set of public methods and a set of API methods of the set of public methods, wherein each method of the set of non-API methods is not called by other modules of the object oriented program, each method of the set of API methods being declared in at least one API of the one or more APIs of the at least one module.

21. The system according to claim 17, wherein the processing module is further configured for calculating the at least one metric associated with the API based coupling of the at least one module, the at least one metric being based on a set of abstract methods and a set of concrete methods, each abstract method of the set of abstract methods being defined in a class of the object oriented program and called by at least one method of the one or more methods, each concrete method of the set of concrete methods is defined in a class of an inheritance hierarchy and called by at least one method of the one or more methods.

22. The system according to claim 17, wherein the processing module is further configured for calculating the at least one metric associated with the API based coupling of the at least one module, wherein the at least one metric associated with the API based coupling of the at least one module is based on a set of modules of the plurality of modules and a set of methods, wherein each module of the set of modules calls at least one method of one API of the one or more APIs, each method of the set of methods being called by at least one module of the set of modules, wherein each method of the set of methods is declared in the one API.

23. The system according to claim 17, wherein the processing module is further configured for calculating the at least one metric associated with the inheritance based coupling of the at least one module, the at least one metric being based on a set of concrete methods and number of times each concrete method of the set of concrete methods is overridden, wherein each concrete method of the set of concrete methods is overridden outside a module defining the concrete method, each concrete method of the set of concrete methods being called by at least one method of the one or more methods, each concrete method of the set of concrete methods being defined by at least one of the at least one class and at least one of ancestor classes of the at least one class.

24. The system according to claim 17, wherein the processing module is further configured for calculating the at least one metric associated with the inheritance based coupling of the at least one module, the at least one metric being based on a set of other modules of the plurality of modules, a first set of classes and a second set of classes, each module of the set of other modules having at least one class derived from at least one class of the one or more classes of the at least one module, each class of the first set of classes being derived from at least one class of the one or more classes of the at least one module, each class of the second set of classes is a class of the one or more classes and derived from at least one class of at least one module of the other modules.

25. The system according to claim 17, wherein the processing module is further configured for calculating the at least one metric associated with the association based coupling of the at least one module, the at least one metric being based on a set of other modules of the plurality of modules, a first set of classes and a second set of classes, each module of the set of other modules having at least one class using at least one class of the one or more classes as a parameter in method definitions, each class of the first set of classes using at least one class of the one or more classes as a parameter in method definitions, each class of the second set of classes using at least one class of at least one module of other modules as a parameter in method definitions, wherein each class of the second set of classes is a class of the one or more classes.

26. The system according to claim 17, wherein the processing module is further configured for calculating the at least one metric associated with the size of the at least one module, the at least one metric being based on an average size of the at least one module and standard deviation of the average size of the at least one module, the average size of the at least one module being associated with the number of classes in the at least one module.

27. The system according to claim 17, wherein the processing module is further configured for calculating the at least one metric associated with the size of the at least one module, the at least one metric being based on an average size of the one or more classes of the at least one module and standard deviation of the average size of the one or more classes, the average size of the one or more classes being associated with the number of methods in each of the one or more classes.

28. The system according to claim 17, wherein the processing module is further configured for calculating the at least one metric associated with the size of the at least one module, the at least one metric being based on an average size of the one or more classes of the at least one module and standard deviation of the average size of the one or more classes, the average size of the one or more classes being associated with the number of lines of code in each of the one or more classes.

29. The system according to claim 17, wherein the processing module is further configured for calculating the at least one metric associated with the state access based coupling of the at least one module, the at least one metric being based on a first set of attributes, a set of other modules, a second set of attributes and a set of classes, each attribute of the first set of attributes being an attribute of the one or more attributes and being accessed by at least one class of at least one module of other modules, each module of the set of other modules accessing at least one attribute of the one or more attributes, each attribute of the second set of attributes being defined in at least one class of the one or more classes and being accessed by other classes of the one or more classes, each class of the set of classes being a class of the one or more classes and accessing at least one attribute of other classes of the one or more classes.

30. The system according to claim 17, wherein the processing module is further configured for calculating the at least one metric associated with the usage of the at least one module, wherein the at least one metric associated with the usage of the at least module is further based a set of classes and a set of modules of the plurality of modules, each class of the set of classes being used together in the object oriented program, wherein each module of the set module defines at least one class of the set of classes.

31. A computer program product for use with a computer, the computer program product comprising a computer usable medium having a computer readable program code embodied therein for assessing modularity of an object oriented program, a plurality of properties being associated with the object oriented program, the object oriented program comprising a plurality of modules, at least one module of the plurality of modules comprising one or more classes and one or more application programming interfaces (APIs), at least one class of the one or more classes comprising one or more attributes and one or more methods, the computer readable program code performing:
a. calculating at least one metric for each of the at least one module, wherein the each of the at least one metric is associated with one property of the plurality of properties associated with the object oriented program; and
b. analyzing the at least one calculated metric based on a pre-defined threshold value, wherein the analysis facilitates the assessment of the modularity of the object oriented program.

32. The computer program product according to claim 31, wherein the one property of the plurality of properties is one of API based coupling of the at least one module, inheritance based coupling of the at least one module, association based coupling of the at least one module, state access based coupling of the at least one module, size of the at least one module and usage of the at least one module.

33. The computer program product according to claim 31, wherein the computer readable program code further performs generating one or more graphical reports based on the analysis of the at least one calculated metric.

34. The computer program product according to claim 32, wherein the at least one metric associated with the API based coupling of the at least one module is based on a first set of external calls and a second set of external calls, each of the first set of external calls being made to a subset of the one or more methods, the subset of the one or more methods being declared in at least one API of the one or more APIs of the at least one module, each of the second set of external calls being made to the one or more methods.

35. The computer program product according to claim 32, wherein the at least one metric associated with the API based coupling of the at least one module is based on a set of public methods of the one or more methods, a set of non-API methods of the set of public methods and a set of API methods of the set of public methods, wherein each method of the set of non-API methods is not called by other modules of the object oriented program, each method of the set of API methods being declared in at least one API of the one or more APIs of the at least one module.

36. The computer program product according to claim 32, wherein the at least one metric associated with the API based coupling of the at least one module is based on a set of abstract methods and a set of concrete methods, each abstract method of the set of abstract methods being defined in a class of the object oriented program and called by at least one method of the one or more methods, each concrete method of the set of concrete methods being defined in a class of an inheritance hierarchy and called by at least one method of the one or more methods.

37. The computer program product according to claim 32, wherein the at least one metric associated with the API based coupling of the at least one module is based on a set of modules of the plurality of modules and a set of methods, wherein each module of the set of modules calls at least one method of one API of the one or more APIs, each method of the set of methods being called by at least one module of the set of modules, wherein each method of the set of methods is declared in the one API.

38. The computer program product according to claim 32, wherein the at least one metric associated with the inheritance based coupling of the at least one module is based on a set of concrete methods and number of times each concrete method of the set of concrete methods is overridden, wherein each concrete method of the set of concrete methods is overridden outside a module of the plurality of modules defining the concrete method, each concrete method of the set of concrete methods being called by at least one method of the one or more methods, each concrete method of the set of concrete methods being defined by at least one of the at least one class and at least one of ancestor classes of the at least one class.

39. The computer program product according to claim 32, wherein the at least one metric associated with the inheritance based coupling of the at least one module is based on a set of other modules of the plurality of modules, a first set of classes and a second set of classes, each module of the set of other modules having at least one class derived from at least one class of the one or more classes of the at least one module, each class of the first set of classes being derived from at least one class of the one or more classes of the at least one module, each class of the second set of classes is a class of the one or more classes and derived from at least one class of at least one module of the other modules.

40. The computer program product according to claim 32, wherein the at least one metric associated with the association based coupling of the at least one module is based on a set of other modules of the plurality of modules, a first set of classes and a second set of classes, each module of the set of other modules having at least one class using at least one class of the one or more classes as a parameter in method definitions, each class of the first set of classes using at least one class of the one or more classes as a parameter in method definitions, each class of the second set of classes using at least one class of at least one module of other modules as a parameter in method definitions, wherein each class of the second set of classes is a class of the one or more classes.

41. The computer program product according to claim 32, wherein the at least one metric associated with the size of the at least one module is based on an average size of the at least one module and standard deviation of the average size of the at least one module, the average size of the at least one module being associated with the number of classes in the at least one module.

42. The computer program product according to claim 32, wherein the at least one metric associated with the size of the at least one module is based on an average size of the one or more classes of the at least one module and standard deviation of the average size of the one or more classes, the average size of the one or more classes being associated with the number of methods in each of the one or more classes.

43. The computer program product according to claim 32, wherein the at least one metric associated with the size of the at least one module is based on an average size of the one or more classes of the at least one module and standard deviation of the average size of the one or more classes, the average size of the one or more classes being associated with the number of lines of code in each of the one or more classes.

44. The computer program product according to claim 32, wherein the at least one metric associated with the state access based coupling of the at least one module is based on a first set of attributes, a set of other modules, a second set of attributes and a set of classes, each attribute of the first set of attributes being an attribute of the one or more attributes and being accessed by at least one class of at least one module of other modules, each module of the set of other modules accessing at least one attribute of the one or more attributes, each attribute of the second set of attributes being defined in at least one class of the one or more classes and being accessed by other classes of the one or more classes, each class of the set of classes being a class of the one or more classes and accessing at least one attribute of other classes of the one or more classes.

45. The computer program product according to claim 32, wherein the at least one metric associated with the usage of the at least module is further based a set of classes and a set of modules of the plurality of modules, each class of the set of classes being used together in the object oriented program, wherein each module of the set module defines at least one class of the set of classes.
